(19) United States
(12) Patent Application Publication
(10) Pub. No.: US 2006/0204287 A1
(43) Pub. Date: Sep. 14, 2006

(54) Image recording apparatus and a print system using the same

(75) Inventor: Tatsuya Konagaya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/370,998

(22) Filed: Mar. 9, 2006

(30) Foreign Application Priority Data
Mar. 10, 2005 (JP) 2005-067440

(51) Int. Cl. G03G 15/16

(52) U.S. Cl. 399/296

(57) ABSTRACT

The image recording apparatus includes a receiving device for receiving order data having image data and related processing information; an image recording device for recording an image on a recording material; a magazine which supplies it to the image recording device; an ejecting device having first and second ejection ports from which the image recording material is rejected; a first transport path extending to the first ejection port; a second transport path extending to the second ejection port; a transport path changeover device which can switch between a first state where the recording material is transported toward the first transport path and a second state where the recording material is transported toward the second transport path; and a changeover control device which switches the transport path changeover device when a crash-processed recording material passes by a point of divergence.

The entire content of the document cited in this specification is incorporated herein by reference.

### BACKGROUND OF THE INVENTION

This invention relates to an image recording apparatus by means of which the picture taken with a digital camera or the like is recorded on recording materials. The invention also relates to a print system using the apparatus.

As personal computers (PCs) and PDAs (personal digital assistants) are increasingly used, the penetration rate of digital cameras is growing. This is also true with cellular phones having a picture-taking capability.

Pictures taken with a digital camera, a cellular phone and the like are usually captured as image data into a PC or the like, where they are processed for use in a variety of applications including posting on Internet websites and duplicating on New Year's cards. An equally strong demand exists for permanently recording those pictures as high-quality (photographic) prints. A so-called digital mini-lab is currently in commercial use and it comprises a scanner with which the picture recorded on a film is photoelectrically read with a CCD sensor or the like, a control unit which converts the captured picture into digital signals (image data) and performs various image processing steps on the digital signals so as to produce output image data, and an image recording unit which scan exposes photographic paper with recording light such as laser light modulated in accordance with the output image data and which subsequently applies specified wet processing steps to the exposed photographic paper. Handling the picture as image data, the digital mini-lab finds it easy to cope with the need to prepare prints from the picture taken with a digital camera or the like.

Under these circumstances, photo labs and other dedicated photo shops have recently come to adopt the digital mini-lab for the purpose of preparing prints from the pictures taken with a digital camera, a cellular phone and the like.

Preparing prints from the pictures taken with a digital camera and the like involves no wet processing of films, so the overall work is simple and fast. Speaking of the digital mini-lab, efforts are being made to increase the processing speed while improving the precision in processing and the efficiency of operation. Efforts are also being made to increase the speed of wet processing the exposed photographic paper (see, for example, JP 2004-310061 A).

Thus, preparing prints from the pictures taken with a digital camera and the like has the advantage that the time taken between the receipt of a customer's order for print preparation and the handing down of a finished print to the customer can be considerably shortened compared to the case of preparing prints from conventional films.

However, if customers place more orders for print than a digital mini-lab can process in a specified period of time, the amount of time required between the receipt of a customer's order for print preparation and the handing down of a finished print to the customer is prolonged. As a result, an urgent need for print cannot be met and an unduly long time is taken between the receipt of a customer's order for print preparation and the handing down of a finished print to the customer.

In image recording apparatuses, the prints they have prepared are outputted to a sorter or the like in the order of cases, so it is difficult to determine whether a particular print is under such an order that it needs to be handed down to the customer as soon as possible. This gives rise to the difficulty in selectively handing down a print of higher priority order to the customer, namely, picking up a print under such an order that it has to be handed down to the customer as soon as possible after it has passed through the necessary processing steps.

### SUMMARY OF THE INVENTION

An object, therefore, of the present invention is to provide an image recording apparatus that can pick up prints for cases of higher priority in a rapid and correct manner.

Another object of the present invention is to provide an image recording apparatus which, in addition to the feature just described above, can perform development on print data for cases of higher priority in a shorter period of time and which, if the situation permits, allows the customer to receive a finished print either on the site or at the nearest counter after waiting for only a short period of time.

A further object of the present invention is to provide a print system that uses either of the above-described apparatuses.

To attain the first object of the present invention, there is provided according to its first aspect an image recording apparatus comprising a receiving device for receiving order data comprising one or more frames of image data and processing information related thereto, an image recording device for recording an image reproducing the image data on a recording material, a magazine which accommodates the recording material and supplies it to the image recording device, an ejecting device comprising at least two ejection ports, which are a first ejection port and a second ejection port and from which the image recording material on which the reproduced image has been recorded by the image recording device is ejected, a first transport path extending from the magazine to the first ejection port, a second transport path diverging from the first transport path to extend to the second ejection port, a transport path changeover device which is provided at a point where the second transport path diverges from the first transport path and which is capable of switching between a first state where the recording material is transported toward the first transport path and a second state where the recording material is transported toward the second transport path, and a changeover control device which determines whether the order data contains information for crash processing as the processing information and which, if the result of such determination is positive, switches the transport path changeover device in the first state to be brought into the second state when a crash-processed recording material on which an image that reproduces the image data in the order data containing the information for crash processing has been recorded passes by the point of divergence.

Preferably, the image recording apparatus further comprises a notifying device which notifies ejection of the crash-processed recording material through the second ejection port.

It is also preferred that the image recording apparatus further comprises an ejection direction changeover device by means of which the recording material to be ejected through the second ejection port is rotated so that the direction of its ejection is changed for each of the order data.

It is also preferred that the image recording apparatus further comprises a device by means of which a recording material of a different length than the recording material that records the image of the image data in the order data containing the information for crash processing or an index print for the image data in the order data is ejected either immediately before the crash-processed recording material is ejected or immediately after all crash-processed recording materials for one case have been ejected or on both occasions.

In another preferred case, the image recording apparatus further comprises a sorting device which is provided downstream of the second ejection port in the direction of transport of the recording material to sort the recording material either by order data or in a group of a specified number of sheets as it has been ejected through the second ejection port.

Preferably, the ejecting device causes the recording material to be ejected through the ejection ports with the image recording side facing down.

The changeover control device is preferably such that it determines whether the recording material is unnecessary or not and which, if it is found unnecessary, switches the transport path changeover device in the first state to be brought into the second state when the unnecessary recording material passes by the point of divergence.

Preferably, the magazine supplies the image recording device with at least the recording material of normal size and a recording material of a larger size, and the changeover control device determines whether the recording material is of a larger size and, if it is, switches the transport path changeover device in the first state to be brought into the second state when the recording material of a larger size passes by the point of divergence.

Preferably, the ejecting device further comprises at least one auxiliary ejection port, as well as an auxiliary transport path that diverges at the point of divergence between the first transport path and the second transport path and which extends to the auxiliary ejection port, and the transport path changeover device is capable of switching between the first state, the second state and a third state in which the recording material is transported toward the auxiliary transport path, and the changeover control device switches the transport path changeover device in the first state to be brought into either the second state or the third state when the crash-processed recording material passes by the point of divergence.

In order to attain the second object of the present invention, there is provided according to its second aspect the image recording apparatus as defined in any one of the items above which further comprises a control unit which comprises a sequence setting device by which a sequence in which the image recording device performs image recording on the image data is set in accordance with the processing information in the order data.

The sequence setting device is preferably such that if it recognizes the order data containing the information for crash processing, the sequence of the image recording for the image data in the order data containing that information for crash processing is set earlier than in image data for which the sequence of the image recording was already set.

The sequence setting device is preferably such that if it recognizes the order data containing the information for crash processing, the sequence of the image recording for the image data in the recognized order data containing that information for crash processing is set next to order data containing the image data on which the image recording is being performed by the image recording device at the time of recognition.

The sequence setting device is preferably such that if it recognizes the order data containing the information for crash processing, the sequence of the image recording for the image data in the recognized order data containing that information for crash processing is set next to image data on which the image recording is being performed by the image recording device at the time of recognition.

The sequence setting device is preferably such that if it recognizes the order data containing the information for crash processing, the sequence of the image recording on the image data in the recognized order data containing that information for crash processing is set a specified number of frames after image data on which the image recording is being performed by the image recording device at the time of recognition.

According to its third aspect, the present invention provides a print system comprising the image recording apparatus as defined in any one of the items above and an input unit which comprises an image acquisition device for acquiring the image data and an input device for entering the processing information related thereto and which relates the entered processing information to the acquired image data of one or more frames and outputs a result to the image recording apparatus as order data.

Here, it is preferred that the image recording apparatus further comprises a control unit which relates the entered processing information to the image data of the one or more frames to provide the order data.

According to the first aspect of the present invention, the recording material which records the image data in the order data having information for crash processing (urgent processing) is ejected through the second ejection port and this ensures that prints with a higher priority order can be picked up by the operator in an easy, correct and rapid manner.

In addition, the notifying device ensures that the ejection of a print for the order data containing the information for crash processing can be known by the operator with sufficient rapidity that the print for the order data containing the information for crash processing can be picked up more smoothly.

Furthermore, the ejection direction changeover device and/or the device for ejecting a recording material of a different length than the recording material that records an image of the image data in the order data containing the information for crash processing or an index print for the image data in the order data enables the ejected print to be distinguished for each item of the order data with sufficient ease that the print for the order data containing the information for crash processing can be picked up more smoothly.

According to the second aspect of the present invention, the sequence of image recording can be set in accordance with the processing information contained in the order data and this allows an order of higher priority to be printed earlier than others, thus ensuring that all steps from data entry through development can be completed in a short period of time. As a result, users who placed an order have to wait for only a short time before they can receive finished prints either on the site or at the nearest counter.

### BRIEF DESCRIPTION OF THE DRAWINGS

FIG. 1 is a block diagram showing an embodiment of the print system of the present invention;

FIG. 2 shows schematically an outline of the configuration according to an embodiment of the output unit in the image recording apparatus of the present invention; and

FIG. 3 shows schematically an outline of the configuration of the transport path changeover section of the output unit shown in FIG. 2.

### DETAILED DESCRIPTION OF THE PREFERRED EMBODIMENTS

On the following pages, the image recording apparatus of the present invention and the print system using the same are described in detail with reference to the preferred embodiments shown in the attached drawings.

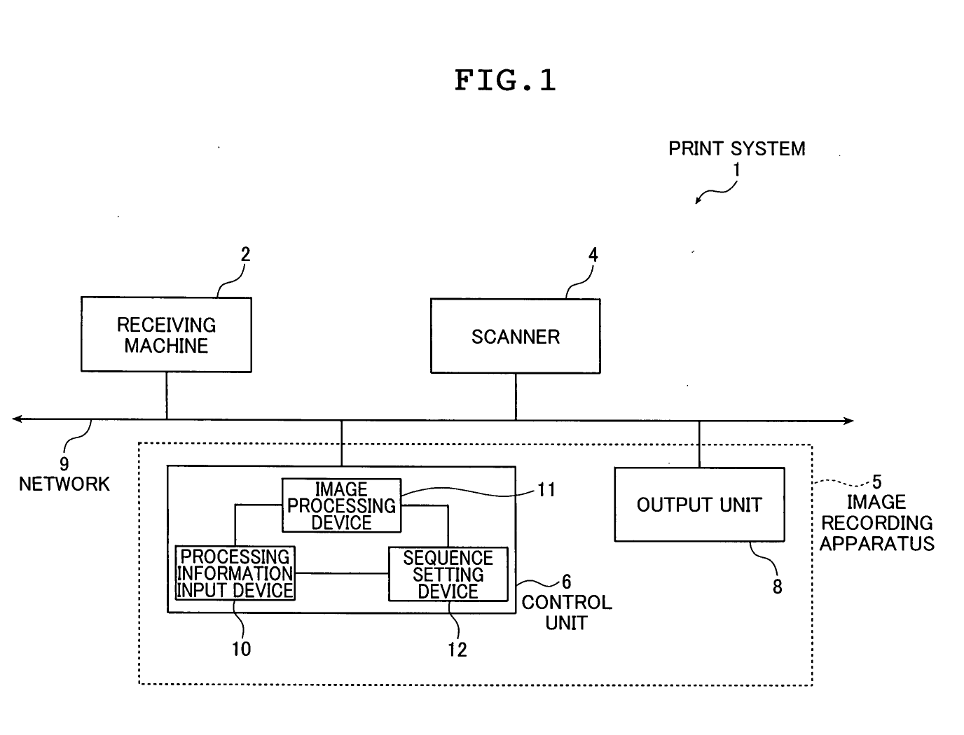

FIG. 1 is a block diagram showing an embodiment of a print system generally indicated at 1 which is the third aspect of the present invention using an image recording apparatus generally indicated by 5 according to the first and second aspects of the present invention.

The print system 1 prepares a (photographic) print in accordance with a customer's order from the piocture taken with a digital camera, a cellular phone or the like. In one example, the print system 1 comprises a print order receiving machine 2 (which is hereinafter referred to as receiving machine 2), a scanner 4, and the image recording apparatus 5 comprising a control unit 6 (system controller 6) and an output unit 8. These components are interconnected in a known network 9 in such a way as to permit mutual reviewing of information and the like, as well as it sending, receiving and the like.

In the illustrated case, the print system 1 has only one unit of each of the receiving machine 2 and the scanner 4, but this is not the sole case of the present invention and the print system 1 may have more than one unit of each of the receiving machine 2 and the scanner 4.

The receiving machine 2, which is typically installed at the counter of a lab shop or in a variety of commercial facilities, receives a customer's order for preparing a print from the image data for the picture taken with an imaging device such as a digital camera or a cellular phone having a picture-taking capability.

The receiving machine 2 reads image from a storage medium loaded in a loading section (not shown) and correlates the entered processing information with a single case of image data (one or more frames of image data) to provide a single case of order data. The receiving machine 2 then supplies the prepared order data into the control unit 6.

The processing information comprises various kinds of information such as for normal finishing (normal processing) and crash finishing (crash processing); such information is manually entered by the operator, a customer (user) and the like; alternatively, it is set automatically by the control unit 6. The term “normal finishing” as used herein refers to information for such a setting that the processing for print preparation is performed in the basic sequence as determined by the sequence in which orders were received; the term “crash finishing” refers to information for such a setting that a case an order for the processing of which was already placed is skipped to effect preferential print preparation as early as possible.

The storage media that are compatible with the receiving machine 2 of the present invention are not limited in any particular way and various types of storage media can be employed, as exemplified by Smart Media™, Compact Flash™, Memory Stick™, SM Memory Card™, PC card, CD-R, MD, etc. The storage media that are compatible with the receiving machine 2 are not limited to any single type and the receiving machine 2 may be designed to be cope with a plurality of storage media.

If desired, the receiving machine 2 may use a specified connecting means and the like to read the image data directly from a digital camera, a cellular phone, and the like.

The scanner 4 is a device that acquires image data by photoelectrically reading the image recorded on a photographic film. The scanner 4 sends the thus read image data to the control unit 6 for each case; for example, one case may consist of one or more frames of image data as obtained by reading the image recorded on one roll of film.

The control unit 6 comprises a processing information input device 10, an image processing device 11 and a sequence setting device 12; in the control unit 6, the image data as supplied from the receiving machine 2 or the scanner 4 is subjected to a specified image processing scheme to generate output image data that is associated with print preparation by the output unit 8, and this output image data is correlated with the processing information to provide output image data, with the result of correlation being supplied to the output unit 8. The control unit 6 also supplies the output unit 8 with sort information that represents the period of sending image of one case, as well as recording sequence information that represents the sequence of image recording.

The processing information input device 10 enters the processing information per case of the image data as supplied from the scanner 4; in the processing information input device 10, one case of image data as supplied from the scanner 4 is correlated with the processing information to generate one case of order data. The processing information input device 10 can also change the processing information in the order data as supplied from the receiving machine 2. Here, the processing information may be manually entered by the operator; alternatively, it may be entered automatically. If the processing information is to be added automatically, “normal finishing” may at all times be added as the processing information to the image data as supplied from the scanner 4.

In the embodiment under consideration, image data is acquired by either the receiving machine 2 or the scanner 4. In the former case, the receiving machine 2 enters the processing information and correlates it with one case of image data to provide one case of order data. If desired, instead of correlating the acquired image data with the processing information in the receiving machine 2, a single case of image data that is yet to be correlated with the processing information may be supplied from the receiving machine 2 into the control unit 6 and the processing information may then be entered by the processing information input device 10 and correlated with the single case of image data to generate a single case of order data.

The image processing device 11 performs specified image processing steps on each of the image data as supplied from the receiving machine 2 or the scanner 4. The image processing steps to be performed by the image processing device 11 are not limited in any particular way and a variety of known image processing steps may be applied, as exemplified by image enlargement/reduction (electronic scaling), gradation correction, color/density correction, saturation correction, and sharpening. Each of these image processing steps may be performed by known methods.

The sequence setting device 12 sets the sequence of recording the image data in the output unit 8 in accordance with the processing information in the order data. In principle, the sequence setting device 12 sets the sequence of image data recording in the output unit 8 depending on which case was received earlier; in the case of order data which has been entered together with a special kind of processing information such as for crash finishing, the sequence setting device 12 may, if necessary, sets the recording sequence in such a way that image recording for the image data contained in the order data entered together with the processing information for crash finishing (which is hereinafter referred to simply as “order data for crash finishing”) is performed earlier than the case that has been set for “early recording” (by skipping the “early” case).

Thus, the recording sequence for crash finishing is set to skip the “early” case and shorten the time between the receipt of an order for crash finishing and the actual end of finishing steps. As a result, even users who want a print to be prepared in a short time can be dealt with and they have to wait for only a short time before getting finished prints either on the site or at the nearest counter.

Note that the setting performed by the sequence setting device 12 for allowing the order data for crash finishing to skip the “early” case” in the recording sequence may be in any mode. In other words, the image recording for the image data contained in the order data for crash finishing may be operator set to follow any desired sequence.

The recording sequence for the order data for crash finishing is preferably set as follows so that it skips (gets ahead of) the “early” case: when the order data for crash finishing is received (its signal received or it is recognized), the image data contained in the order data for crash finishing is recorded as an image on a sheet of recording paper next to the image data of the case being subjected to image recording in the output unit 8 at the time of data reception (signal reception or recognition), namely, subsequent to the order data in the process of image recording.

As a result, even users who want a print to be prepared in a short time can be dealt with and they have to wait for only a short time before receiving finished prints either on the site or at the nearest counter; in addition, prints can be prepared positively for each case of order data and print preparation for the case if order data which was undergoing image recording with the output unit 8 at the time when the order data for crash finishing was received is not interrupted but is completed without delay; hence, prints for the order data which was undergoing image recording at the time when the order data for crash finishing was received can also be handed down to the user on schedule (no later than the promised time).

In another preferred embodiment, the recording sequence for the order data for crash finishing may be set as follows so that it skips the “early” case: when the order data for crash finishing is received, the image data contained in the order data for crash finishing is recorded as an image on a sheet of recording paper after a specified number of frames of the image data being subjected to image recording with the output unit 8 at the time of data reception.

This offers the advantage that even if the order data containing the image data being subjected to image recording with the output unit 8 at the time of data reception comprises a large number of sheets to be printed, printing of the order data for crash finishing can be started no later than a specified period of time.

In yet another preferred embodiment, the recording sequence for the order data for crash finishing may be set as follows so that it skips the “early” case: when the order data for crash finishing is received, the image data contained in the order data for crash finishing is recorded as an image on a sheet of recording paper next to the image data being subjected to image recording with the output unit 8 at the time of data reception, namely, by suspending the case in the process of image recording to effect “interruption”.

This offers the advantage of further shortening the time between the receipt of an order for crash finishing and the actual end of finishing steps.

The way the recording sequence for the order data for crash finishing is set so that it skips the “early” case is by no means limited to the above examples and it can be set in various other ways: for example, if the number of frames of the image data in the order data that is being subjected to image recording with the output unit 8 at the time of data reception is smaller than a given value, the image recording for the image data contained in the order data for crash finishing may be set such that it is performed next to the order data being subjected to image recording at the time of data reception; if the number of frames of the image data in the order data that is being subjected to image recording at the time of data reception is greater than the given value, the image recording for the image data contained in the order data for crash finishing may be set such that it is performed after a specified number of frames of the image data being subjected to image recording at the time of data reception.

Preferably, the sequence of image recording for the order data for crash finishing is set in such a way that it does not get ahead of the sequence of image recording for another piece of order data for crash finishing the sequence of image recording for which was already set.

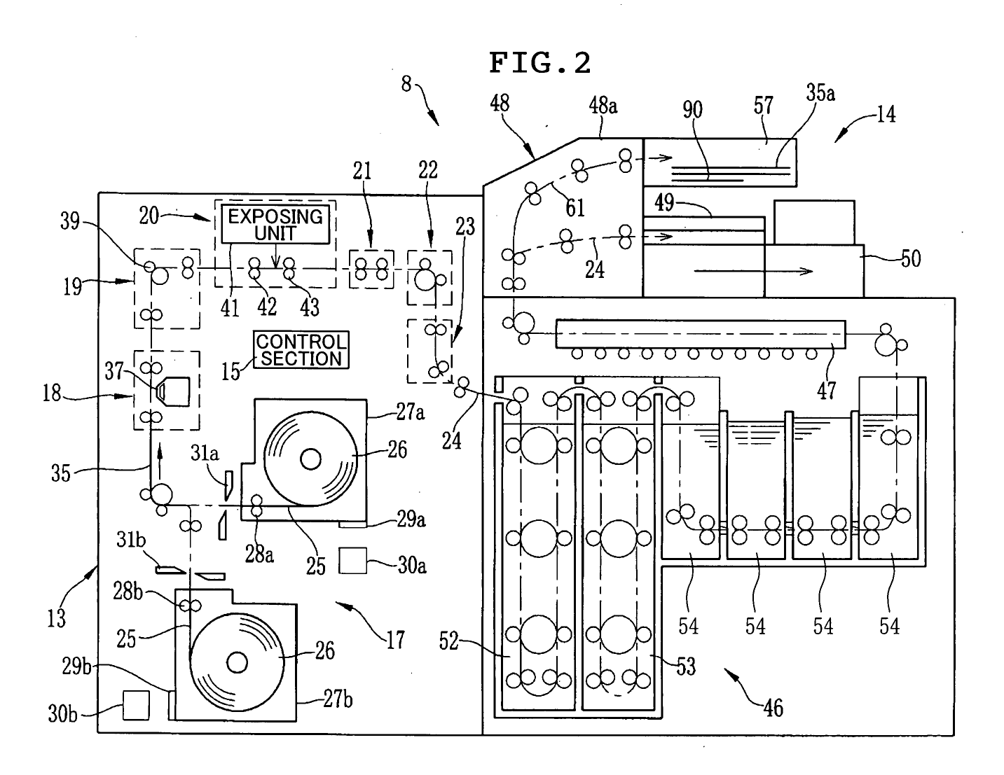

We now describe the output unit 8 in detail by reference to FIG. 2 which shows schematically an outline of the configuration of the output unit 8. As shown, the output unit 8 comprises a printer 13, a processor 14, and a control section 15.

The components of the printer 13 and the processor 14 are connected to the control section 15 via wirings not shown. The control section 15 controls the overall operation of the output unit 8.

The printer 13 records an image on a cut sheet of light-sensitive recording paper (recording material) as it is transported in an auxiliary scanning direction (transport direction); as shown, it comprises a supply section 17, a back printing section 18, a skew correcting section 19, an exposing section (image recording section) 20, an auxiliary scan receiving section 21, a distributing section 22, a delivery section 23, etc. In each of these sections, a plurality of transport roller pairs each consisting of a drive roller and a nip roller are provided along the main transport path 24 for the light-sensitive recording paper (as indicated by the one-short-one-long dashed line in FIG. 2).

Two magazines 27a and 27b are set in the supply section 17, each accommodating a roll 26 of the light-sensitive recording paper 25. Paper feeding roller pairs 28a and 28b are provided within the magazines 27a and 27b, respectively, for drawing out the light-sensitive paper 25 and transporting it toward the back printing section 18. In the embodiments under consideration, two magazines 27a and 27b are provided but their number is not limited in any particular way and only one magazine may be used; alternatively, three or more magazines may be employed. If desired, the light-sensitive paper 25 accomodated in the magazine 27a may have a different width or thickness from the light-sensitive paper 25 accommodated in the magazine 27b. The light-sensitive paper 25 to be accommodated in each of the magazines 27a and 27b typically consists of two or more webs of light-sensitive paper 25 that are joined at opposite ends, with the joint (not shown) being marked by splice holes (also not shown).

The magazines 27a and 27b are also provided with bar codes 29a and 29b, respectively, that have recorded thereon magazine identifying information (magazine ID information) which contains grade information such as thickness and constituent material about the light-sensitive recording paper (its roll 26). In the supply section 17, there are provided two bar code readers 30a and 30b in positions that are opposite the bar codes 29a and 29b, respectively, on the magazines 27a and 27b that have been set in predetermined positions. The magazine ID information as read by the respective bar code readers 30a and 30b is sent to the control section 15.

When the paper feeding roller pairs 28a and 28b are driven to rotate by a paper feeding motor not shown, the light-sensitive recording paper 25 is unrolled to run toward cutters 31a and 31b. The cutters 31a and 31b are driven in response to a control signal from the control section 15. The light-sensitive recording paper 25 that has been sent by a predetermined length in accordance with the size of the print to be prepared is cut with those cutters to form a sheet of recording paper 35. Instead of providing two cutters, a single cutter may be provided in the neighborhood of the back printing section 18.

In the embodiments under consideration, sheets of recording paper 35 are transported in a single row until they reach the distributing section 22 to be described later, so the timing at which the light-sensitive recording paper 25 is supplied from the magazines 27a and 27b is adjusted automatically. If the light-sensitive recording paper 25 accommodated in the magazine 27a is of the same grade as what is in the magazine 27b, the sending of the light-sensitive recording paper from one magazine may be initiated after the entire length of the light-sensitive recording paper has been sent out from the other magazine. The sheets of recording paper 35 that have been formed by cutting with the cutters 31a and 31b are transported through the main transport path 24 by the plurality of transport roller pairs provided along that transport path; the sheets are successively passed through the back printing section 18, skew correcting section 19, exposing section 20, auxiliary scan receiving section 21, distributing section 22, and the delivery section 23.

The back printing section 18 has a back print head 37 that records print information such as the date when the picture was taken, the print date, the frame number, and a variety of IDs on the back side of the sheet of recording paper 35 (which is opposite the recording side). The back print head 37 may be of any known print head such as a dot impact head, an ink-jet head or a thermal transfer print head.

The skew correcting section 19 ensures that no offsets in the exposing position and angle will occur in the exposing section 20; to this end, it comprises a register roller pair 39 that is provided between transport roller pairs to correct any tilt of the sheet of recording paper 35. The register roller pair 39 may correct skew by various known methods including the ones described in JP 60-153358 A and JP 11-349191 A.

The exposing section 20 comprises an exposing unit 41, auxiliary scanning roller pairs 42, 43, etc. Although not shown, well-known types of laser printer and image memory are provided in the exposing unit 41. The image memory stores the image data that has been sent from the control unit 6 via the network 9. In the laser printer, recording light (laser light) that has been intensity modulated in accordance with the image to be recorded performs scan in a main scanning direction perpendicular to the auxiliary scanning direction, whereby imagewise exposure is effected on the sheet of recording paper 35. The exposing unit 41 performs imagewise scan on the sheet of recording paper 35 according to the sequence of recording that has been set by the above-described sequence setting device 12.

The nip rollers of the auxiliary scanning roller pairs 42 and 43 can be switched between two positions, a nip position where they are pressed against the sheet of recording paper 35 to hold it in place and a nip-less position where they depart from the sheet of recording paper 35; the switching occurs when a position sensor (not shown) has detected the leading or trailing edge of the sheet of recording paper 35. This prevents the sheet of recording paper 35 from fluctuating in transport speed during exposure.

The auxiliary scan receiving section 21 has a plurality of roller pairs that hold the leading edge of the sheet of recording paper 35 as it is being sent from the exposing section 20 during exposure, so that the sheet 35 is forwarded downstream the direction of transport (which is hereinafter referred to simply as “downstream”) at the same speed as the sheet is transported through the exposing section 20. Each of the transport roller pairs in the auxiliary scan receiving section 21 consists of a drive roller and a nip roller that can be disengaged from the nip position; as long as the sheet of recording paper 35 is in the process of exposure for recording, it is not nipped by those roller pairs but when its trailing edge has passed through the step of exposure for recording, the nip rollers move to the nip position where they hold the sheet of recording paper 35 in place and transport it to the distributing section 22.

In the distributing section 22, the sheets of recording paper 35 that have been transported in a single row are distributed in more than one row in accordance with the sheet size as they are being transported at a predetermined first speed. For example, if the transported sheets of recording paper 35 are of a regular or small size, they are distributed in two rows; on the other hand, in the case where sheets of recording paper 35a that are too large to be transported in two rows have been transported, they are let to run in a single row as they have been. If desired, the sheets of recording paper 35 that have been transported in a single row may be distributed in three or more rows depending upon the width of the main transport path 24. The distributing section 22 is designed as a replaceable unit and those means which have capacities that comply with the overall processing speed of the output unit 8 may be set in a detachable manner. The delivery section 23 is such that the sheet of recording paper 35 being sent from the distributing section 22 is forwarded to the processor 14 at a second speed that complies with the processing speed of the processor 14.

The processor 14 comprises a photographic processing section 46, a drying section 47, a transport path changeover section 48, a rearranging section 49, a sorter 50, etc. The sheets of recording paper 35 as sent into the processor 14 from the printer 13 are transported through the processor 14 along the transport path indicated by the one-short-and-one-long dashed line in FIG. 2. In the photographic processing section 46, a developing tank 52, a bleach-fixing tank 53, and a washing tank 54 are provided in that order, with the developing tank 52 at the most upstream end. The developing tank 52, bleach-fixing tank 53 and washing tank 54 contain specified volumes of a developing solution, a bleach-fixing solution and a washing solution, respectively. As it passes through the respective tanks 52-54 in that order, the sheet of recording paper 35 is subjected to the developing, bleach-fixing, and washing steps.

The drying section 47, which is provided above the tanks 52-54, comprises a conveyor belt and an air duct that are not shown. Dry air as heated with a heater (not shown) passes through the air duct and is blown against the sheet of recording paper 25 that is being transported over the conveyor belt. This removes the cleaning water that deposited on the sheet of recording paper 35 during cleaning in the washing tank 54. The dried sheet of recording paper (photographic print) 35 is transported to the transport path changeover section 46 provided upward of the exit of the drying section 47 as seen in FIG. 2.

The transport path changeover section 48 embodies the concept of the present invention and its details will be described later. Suffice it here to say that the section has the following functions: the sheets of recording paper (prints) 35 being transported in two rows are sent to the rearranging section 49 and, in addition, in the case where a sheet of recording paper that records as image the image data contained in the order data that had been entered together with processing information for crash finishing (the sheet is hereinafter referred to simply as “crash-finished print”) has been transported, switching of transport paths is effected so that the crash-finished print is transported into a collection box 57 provided downstream an auxiliary transport path 61.

The rearranging section 49 is a site where regular-size sheets of recording paper 35 that have been transported in two rows are rearranged in a single row for subsequent transport and those means which have rearranging capacities that comply with the overall processing capability of the output unit 8 (e.g. a means capable of rapid rearrangement, a means that effects no rearrangement, etc.) are set in the rearranging section 49 in a replaceable manner. The sorter 50 is a means by which the plural sheets of recording paper 35 as sent from the rearranging section 49 are collectively outputted for each print job (for each case).

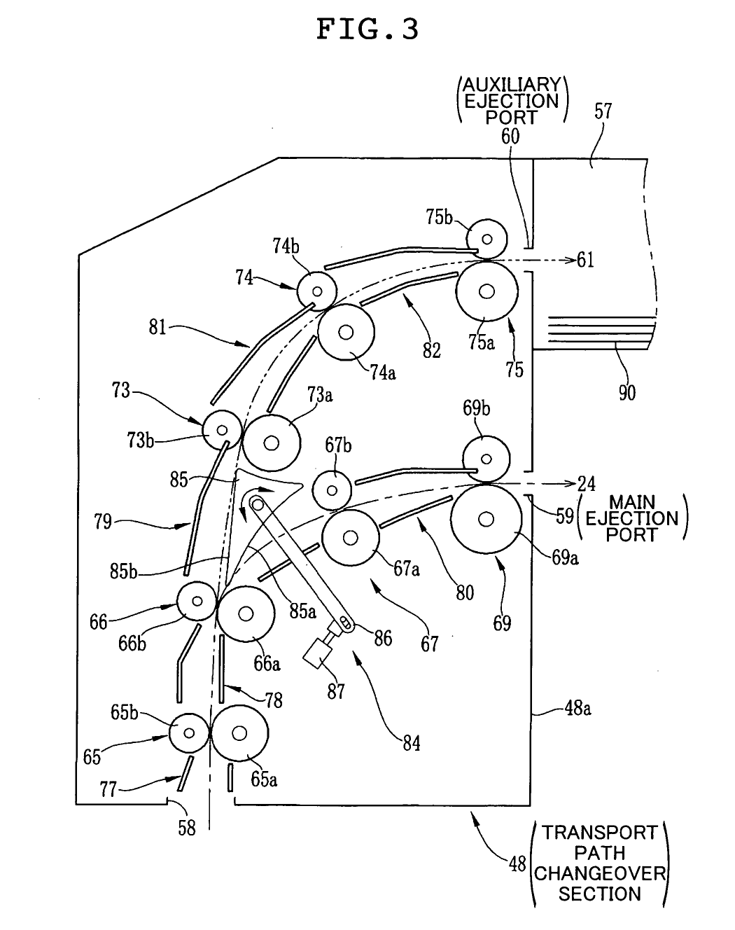

In the next place, we explain the transport path changeover section 48 with reference to FIG. 3. As shown in FIG. 3, the transport path changeover section 48 has a slot 58 in the bottom of its main body 48a, through which to receive the sheet of recording sheet 35 as it has been sent from the drying section 47. That face of the main body 48a which is on the right side of FIG. 3 has a main ejection port (first ejection port) 59 through which the regular-size sheet of recording sheet 35 that has been transported over the main transport path 24 is ejected into the rearranging section 49. Formed upward of the main ejection port 59 is an auxiliary ejection port (second ejection port) 60 through which the large-size sheet of recording paper 35a (see FIG. 2) and the like are ejected into the collecting box 57. The auxiliary transport path 61 is formed in the interior of the main body 48a in such a way that it diverges midway from the main transport path 24 through which the regular-size sheet of recording paper 35 is transported and that it extends toward the auxiliary ejection port 60.

In that part of the main transport path 24 which extends from the slot 58 and the main ejection port 59, there are provided a first transport roller pair 65, a second transport roller pair 66, a third transport roller pair 67, and a high-speed delivery roller pair 69 in that order, with the first transport roller pair 65 being positioned at the most upstream end. The main transport path 24 extends vertically upward from the slot 58 and bends near the main ejection port 59 to extend in a generally horizontal direction. The roller pairs 65-67 and 69 are arranged along the thus bending main transport path 24. The first to third transport roller pairs 65-67 each consist of a capstan roller that is driven to rotate by a transport motor (not shown) and a nip roller as a follower roller. The capstan rollers of the first to third transport roller pairs are indicated by 65a, 66a and 67a, respectively and the nip rollers are indicated by 65b, 66b and 67b, respectively. The capstan rollers 65a-67a and the nip rollers 65b-67b are positioned in such a way that the former cooperate with the latter to hold the main transport path 24 between themselves.

Although not shown, a belt is stretched across the first to third capstan rollers 65a-67a so that they are driven to rotate at substantially the same peripheral speed. The high-speed delivery roller pair 69 also consists of a high-speed drive roller 69a and a high-speed nip roller 69b. Since the high-speed drive roller 69a is designed to be capable of faster rotation than the first to third capstan rollers 65a-67a, the sheet of recording paper 35 can be delivered to the rearranging section 49 in a shortened time. Note that the high-speed drive roller 69a is rotated at the same speed as the first to third capstan rollers 65a-67a until after the trailing edge of the sheet of recording paper 35 leaves the third transport roller pair 67.

In the embodiments under consideration, the auxiliary transport path 61 diverges at a point downstream of the second transport roller pair 66 in the direction of transport and extends toward the auxiliary ejection port 60. In the section between the point of divergence and the auxiliary ejection port 60, there are provided three additional transport roller pairs, a fourth roller pair 73, a fifth roller pair 74, and a sixth roller pair 75. Like the main transport path 24, the auxiliary transport path 61 bends near the auxiliary ejection port 60 to extend in a generally horizontal direction; hence, the fourth to six transport roller pairs 73-75 are arranged along the bending auxiliary transport path 61. The fourth to sixth transport roller pairs 73-75 are basically composed in the same way as the first to third transport roller pairs 65-67; they each consist of a capstan roller and a nip roller, with the fourth to sixth capstan rollers being indicated by 73a-75a and the fourth to sixth nip rollers by 73b-75b; the capstan rollers 73a-75a and the nip rollers 73b-75b are positioned in such a way that the former cooperate with the latter to hold the auxiliary transport path 61 between themselves.

A first transport guide 77 is provided between the slot 58 and the first transport roller pair 65; a second transport guide 78 is provided between the first and second transport roller pairs 65 and 66; a third transport guide 79 is provided between the second and forth transport roller pairs 66 and 73; a fourth transport guide 80 is provided between the third transport roller pair 67 and the high-speed delivery roller pair 69; a fifth transport guide 81 is provided between the fourth and fifth transport roller pairs 73 and 74; and finally, a sixth transport guide 82 is provided between the fifth and sixth transport roller pairs 74 and 75. These transport guides 77-82 have such a function that the leading edge of the sheet of recording paper 35 as it emerges from the upstream transport roller pair is guided to the downstream transport roller pair. The first to sixth transport guides 77-82 may be formed of any material such as metal or resin.

A transport path changeover mechanism 84 is provided at the point where the auxiliary transport path 61 diverges from the main auxiliary transport path 24. The transport path changeover mechanism 84 consists typically of a switch guide 85, an arm member 86 secured at one end to the switch guide 85, and a solenoid 87 coupled to the other end of the arm member 86. The switch guide 85, which is formed of a resin material, has two guide faces, one being the first guide face 85a which directs the regular-size sheet of recording paper 35 toward the third transport roller pair 67 and the second guide face 85b which directs the large-size sheet of recording paper 35a (see FIG. 2) toward the fourth transport roller pair 73. The solenoid 87 is driven under the control of the aforementioned control section 15 (see FIG. 2). Therefore, the sheet transport path can be switched from the main transport path 24 to the auxiliary transport path 61 and vice versa by means of the control section 15 which drives the solenoid 87 to pivot the switch guide 85.

On the following pages, the method of controlling the transport path changeover mechanism 84 by means of the control section 15 is described.

The control section 15 stores the image data for the image recorded on the sheet of recording paper 35 during passage through the exposing section 20 and the processing information in the order data containing that image data; it then tracks the position of the sheet and determines whether the sheet as transported to the switch guide 85 is a crash-processed print or a sheet of recording paper that records as an image the image data contained in the order data that has been entered together with “normal finishing” as processing information or that has not been entered together with “crash finishing” as processing information (this sheet is hereinafter referred to simply as “normal finished print”). In other words, the control section 15 determines whether the sheet as transported to the switch guide 85 is a crash-finished print or not.

At the time when the crash-finished print passes by the switch guide 85, the control section 15 switches the sheet transport path from the main transport path 24 to the auxiliary transport path 61.

As a result, the crash-finished print is transported along the auxiliary transport path 61 and ejected through the auxiliary ejection port 60.

As described above, the image recording apparatus of the present invention (to be more accurate, its output unit) is so designed that the auxiliary transport path 61 diverges midway from the main transport path 24 and that the sheet transport path can be switched from the main transport path 24 to the auxiliary transport path 61 or vice versa. Since a crash-finished sheet of recording paper is ejected through the auxiliary ejection port 60, the crash-finished print can be clearly distinguished from a normal finished print. As a result, the operator can positively pick up the crash-finished print and ensure smoothness in handing it down to the customer.

In a preferred embodiment, the image recording apparatus of the present invention may be equipped with a notifying device which, as soon as a crash-finished print has emerged from the auxiliary ejection port, notifies the operator and the like of the fact that the print has been ejected through the auxiliary ejection port 60. The notifying device may be implemented by various means including sound, voice, lamp, etc. Notification by the notifying device is preferably done each time the ejection of crash-finished prints is completed per case.

Such notifying device enables the operator and the like to be notified of the ejection of the crash-finished print and even in the case of crash finishing where finished prints need to be handed down as soon as possible, the operator has no need to keep an eye on the auxiliary ejection port 60 to see if a crash-finished print is emerging from it and yet the operator can recognize the ejection of the crash-finished print as soon as it occurs; as a result, the operator can ensure greater smoothness in picking up the crash-finished print and handing it down to the customer. As a further advantage, since the operator is notified of an ejection of crash-finished prints for every case, he or she just does not have to remain on the alert for the ejection of crash-finished prints in order to pick them up efficiently.

In the embodiments under consideration, the crash-finished print is ejected through one auxiliary ejection port but this is not the sole case of the present invention and two or more auxiliary ejection ports may be provided. If two or more auxiliary ejection ports are to be provided, it goes without saying that the auxiliary transport path is provided in association with each auxiliary ejection port and that the transport path for the sheet of recording paper is switched by means of the transport path changeover section. In this particular case where two or more auxiliary ejection ports are provided and a path for transporting the sheet of recording paper is provided in association with each of the auxiliary ejection ports, the sheet transport path is switched by the changeover means, thus enabling crash-finished prints to be ejected through different ejection ports depending on the case (i.e., by order data), whereby the crash-finished prints can be clearly distinguished by case. As a result, even in the case where crash-finished prints are successively ejected, the operator can selectively pick up those prints in accordance with specific cases.

In yet another preferred embodiment, the print being ejected from the auxiliary ejection port may be rotated through a certain angle, say, 90 degrees so that the direction of print ejection is changed in each case. This is another way of enabling the operator to clearly distinguish the crash-finished prints by case.

In a still another preferred embodiment, either immediately before or after the ejection of one case of crash-finished prints or at both times, namely, immediately before a crash-finished print is ejected and/or immediately after all of the crash-finished prints for one case have been ejected, a parting print of a different length than the crash-finished print or an index print for the order data may be ejected. This method (i.e., ejecting a parting index of a different length than the crash-finished print or an index print for the order data either immediately before or after the ejection of one case of crash-finished prints or at both times, namely, between successive cases) is another way of enabling the operator to clearly distinguish the crash-finished prints by case.

The two preferred embodiments just described above, where the direction of print ejection is changed in each case and where a parting index of a different length than the crash-finished print or an index print for the order data either immediately before or after the ejection of one case of crash-finished prints or at both times, have the advantage of requiring a simpler configuration of apparatus than in the above-described case of providing a plurality of auxiliary ejection ports and, hence, the equipment cost can be reduced and yet the crash-finished prints can be clearly distinguished by case.

It should also be noted that the method of distinguishing the crash-finished prints by case is in no way limited to the foregoing and, if desired, a sorter may also be provided at the auxiliary ejection port 60 so that crash-finished prints are sorted out as they successively leave the auxiliary ejection port 60.

It should also be mentioned that prints are preferably ejected through the associated ejection ports in such a way that the image carrying side of each print will face down (as seen in FIG. 3), namely, with the back print carrying side facing up (and the image carrying side not visible to the operator).

Since this orientation causes the back print carrying side of each print to face up, the operator will find it easier to identify each case of order by looking at that back print carrying side.

In all embodiments described above, a check is made to see whether the sheet arriving at the switch guide 85 is a crash-finished print or not and if the answer is yes, the sheet transport path is switched from the main transport path 24 to the auxiliary transport path 61 so that the crash-finished print is ejected through the auxiliary ejection port 60. This is not the sole case of the present invention and large-size sheets of recording paper may also be ejected through the auxiliary ejection port 60.

If large-size sheets of recording paper as well as crash-finished ones are ejected through the auxiliary ejection port 60, regular-size prints can be collected separately from the large-size prints and the main ejection port 59 needs to cope with the regular-size prints only.

In yet another embodiment, any unwanted sheet (light-sensitive recording paper 25) that is not a saleable product, as exemplified by a calibration print for use in correcting the recording density, or a joint (splice sheet) between adjacent pieces of light-sensitive recording paper 25 that is to be cut off by means of the cutter 31a or 31b in order to form the sheet of recording paper 24, or the leading edge (fogged sheet) of the light-sensitive recording paper 25 which is also to be cut off when it is unwound from the roll 26 may be ejected through the auxiliary ejection port 60. In this case, too, the position of the calibration print, the splice sheet or the fogged sheet may be tracked so that the sheet transport path is switched to the auxiliary transport path 61 when those sheets have been transported down to the switch guide 85.

Ejecting unwanted sheets through the auxiliary ejection port 60 in that way contributes to preventing regular or normal prints from mixing up with unwanted sheets. Consequently, the operator does not have any unwanted recording material to remove.

In the embodiments under consideration, the image recording apparatus stores the correspondence between the sheet of recording paper and the processing information and then tracks the position of the sheet of recording paper to determine whether the sheet as transported to the switch guide 85 is a crash-finished print or not. However, this is not the sole case of the present invention and the following modification may be made: a mark indicating that a particular sheet of recording paper is a crash-finished print is formed in a non-image area, say, the back print portion of the print and a mark detector for detecting the mark on the sheet of recording paper is provided upstream of the transport path changeover mechanism in the direction of transport, and a check is made by that mark detector to see whether the sheet transported to the switch guide 85 is the crash-finished print or not.

In the embodiments described above, the magazines 27a and 27b accommodate the light-sensitive recording paper 25 as wound up in roll form 26; this is not the sole case of the present invention and the magazines may accommodate sheets of light-sensitive recording paper 25 that have been cut to a predetermined size.

It should also be added that the present invention is in no way limited to an image recording apparatus that prepares photographic prints and the concept of the invention is also applicable to various types of printers that record image on a sheet of recording material, as exemplified by a thermal printer, a thermal transfer printer, and an ink-jet printer.

What is claimed is:

1. An image recording apparatus, comprising:
a receiving device for receiving order data comprising one or more frames of image data and processing information related thereto;
an image recording device for recording an image reproducing the image data on a recording material;
a magazine which accommodates the recording material and supplies it to the image recording device;
an ejecting device comprising at least two ejection ports, which are a first ejection port and a second ejection port and from which the image recording material on which the reproduced image has been recorded by the image recording device is ejected;
a first transport path extending from the magazine to the first ejection port;
a second transport path diverging from the first transport path to extend to the second ejection port;
a transport path changeover device which is provided at a point where the second transport path diverges from the first transport path and which is capable of switching between a first state where the recording material is transported toward the first transport path and a second state where the recording material is transported toward the second transport path; and
a changeover control device which determines whether the order data contains information for crash processing as the processing information and which, if a result of such determination is positive, switches the transport path changeover device in the first state to be brought into the second state when a crash-processed recording material on which an image that reproduces the image data in the order data containing the information for crash processing has been recorded passes by a point of divergence.

2. The image recording apparatus according to claim 1, further comprising a notifying device which notifies ejection of the crash-processed recording material through the second ejection port.

3. The image recording apparatus according to claim 1, further comprising an ejection direction changeover device by means of which the recording material to be ejected through the second ejection port is rotated so that the direction of its ejection is changed for each of the order data.

4. The image recording apparatus according to claim 1, further comprising a device by means of which a recording material of a different length than the recording material that records the image of the image data in the order data containing the information for crash processing or an index print for the image data in the order data is ejected either immediately before the crash-processed recording material is ejected or immediately after all crash-processed recording materials for one case have been ejected or on both occasions.

5. The image recording apparatus according to claim 1, further comprising a sorting device which is provided downstream of the second ejection port in the direction of transport of the recording material to sort the recording material either by order data or in a group of a specified number of sheets as it has been ejected through the second ejection port.

6. The image recording apparatus according to claim 1, wherein the ejecting device causes the recording material to be ejected through the ejection ports with the image recording side facing down.

7. The image recording apparatus according to claim 1, wherein the changeover control device is such that it determines whether the recording material is unnecessary or not and which, if it is found unnecessary, switches the transport path changeover device in the first state to be brought into the second state when the unnecessary recording material passes by the point of divergence.

8. The image recording apparatus according to claim 1, wherein the magazine supplies the image recording device with at least the recording material of normal size and a recording material of a larger size, and the changeover control device determines whether the recording material is of a larger size and, if it is, switches the transport path changeover device in the first state to be brought into the second state when the recording material of a larger size passes by the point of divergence.

9. The image recording apparatus according to claim 1,
wherein the ejecting device further comprises at least one auxiliary ejection port, as well as an auxiliary transport path that diverges at the point of divergence between the first transport path and the second transport path and which extends to the auxiliary ejection port,
wherein the transport path changeover device is capable of switching between the first state, the second state and a third state in which the recording material is transported toward the auxiliary transport path, and
wherein the changeover control device switches the transport path changeover device in the first state to be brought into either the second state or the third state when the crash-processed recording material passes by the point of divergence.

10. The image recording apparatus according to claim 1, further comprising a control unit which comprises a sequence setting device by which a sequence in which the image recording device performs image recording on the image data is set in accordance with the processing information in the order data.

11. The image recording apparatus according to claim 10, wherein the sequence setting device is such that if it recognizes the order data containing the information for crash processing, the sequence of the image recording for the image data in the order data containing that information for crash processing is set earlier than in image data for which the sequence of the image recording was already set.

12. The image recording apparatus according to claim 10, wherein the sequence setting device is such that if it recognizes the order data containing the information for crash processing, the sequence of the image recording for the image data in the recognized order data containing that information for crash processing is set next to order data containing the image data on which the image recording is being performed by the image recording device at the time of recognition.

13. The image recording apparatus according to claim 10, wherein the sequence setting device is such that if it recognizes the order data containing the information for crash processing, the sequence of the image recording for the image data in the recognized order data containing that information for crash processing is set next to image data on which the image recording is being performed by the image recording device at the time of recognition.

14. The image recording apparatus according to claim 10, wherein the sequence setting device is such that if it recognizes the order data containing the information for crash processing, the sequence of the image recording on the image data in the recognized order data containing that information for crash processing is set a specified number of frames after image data on which the image recording is being performed by the image recording device at the time of recognition.

15. A print system which comprises an input unit and an image recording apparatus, wherein:
the input unit comprises an image acquisition device for acquiring image data and an input device for entering processing information related thereto, and relates the entered processing information to the acquired image data of one or more frames and outputs a result to the image recording apparatus as order data; and
the image recording apparatus, comprises:
a receiving device for receiving the order data comprising one or more frames of image data and the processing information related thereto;
an image recording device for recording an image reproducing the image data on a recording material;
a magazine which accommodates the recording material and supplies it to the image recording device;
an ejecting device comprising at least two ejection ports, which are a first ejection port and a second ejection port and from which the image recording material on which the reproduced image has been recorded by the image recording device is ejected;
a first transport path extending from the magazine to the first ejection port;
a second transport path diverging from the first transport path to extend to the second ejection port;
a transport path changeover device which is provided at a point where the second transport path diverges from the first transport path and which is capable of switching between a first state where the recording material is transported toward the first transport path and a second state where the recording material is transported toward the second transport path; and
a changeover control device which determines whether the order data contains information for crash processing as the processing information and which, if the result of such determination is positive, switches the transport path changeover device in the first state to be brought into the second state when a crash-processed recording material on which an image that reproduces the image data in the order data containing the information for crash processing has been recorded passes by a point of divergence.

16. The print system according to claim 15, wherein the image recording apparatus further comprises a control unit which relates the entered processing information to the image data of the one or more frames to provide the order data.
